(19) United States
(12) Patent Application Publication
(10) Pub. No.: US 2005/0188317 A1
(43) Pub. Date: Aug. 25, 2005

(54) Initiate multiple applications

(75) Inventors: David A. Matthews, Seattle, WA (US); Kanwal VedBrat, Seattle, WA (US); Hillel N. Cooperman, Sammamish, WA (US); Sterling M. Reasor, Bellevue, WA (US); Charles Cummins, Seattle, WA (US); J. Craig Hally, Sammamish, WA (US); Mark R. Ligameri, Snohomish, WA (US); Timothy P. McKee, Seattle, WA (US); Giampiero M. Sierra, Seattle, WA (US); Timothy D. Noonan, Issaquah, WA (US); Eric R. Flo, Sammamish, WA (US); Charles W. Stabb, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/784,003

(22) Filed: Feb. 20, 2004

(51) Int. Cl. G06F 3/00

(52) U.S. Cl. 715/744; 715/845; 715/765; 715/767; 715/778; 715/733; 715/741; 715/743; 715/747

(57) ABSTRACT

In an implementation of initiate multiple applications, a user interface includes a user-selectable control to initiate that multiple applications start together at approximately a same time. The user interface includes user-selectable configurations to designate a multiple application start-up configuration.

### TECHNICAL FIELD

This invention relates to initiating multiple applications.

### BACKGROUND

When a computing device is turned-on, or logged-off of by another user, a user of the computing device is presented with a user interface display to logon to the computing device. When the user selects an account to initiate a computing session and provides a password if necessary, the user interface logon display disappears (e.g., is no longer displayed) and, after a delay, the user is presented with a user interface desktop that may include various icons, and selectable commands, files, controls, and/or links by which the user may begin the computing session.

However, when a user initiates the computing session from the user interface logon display, there is no continuity from the user interface logon display to the user interface desktop. The display may appear to change suddenly from the logon display to the desktop display, or a blank display may appear for a duration after the logon display and before the desktop display. This sudden change or blank delay detracts from the overall user experience when interfacing with the computing system.

### SUMMARY

Initiate multiple applications is described herein.

In an implementation, a user interface includes a user-selectable control to initiate that multiple applications start together at approximately a same time. The user interface includes selectable configurations that are user-selectable to designate a multiple application start-up configuration.

In another implementation, multiple user selections that each correspond to an application program are received. The selected application programs are not started until receiving a user input to initiate that the multiple selected application programs be started together at approximately a same time.

### BRIEF DESCRIPTION OF THE DRAWINGS

The same numbers are used throughout the drawings to reference like features and components. The design, structure, and functional configurations of the user interfaces illustrated in the drawings are merely exemplary to illustrate various features and aspects of initiate multiple applications. Any number of different user interface designs, structures, and functions may be implemented in varying configurations to implement embodiments of initiate multiple applications.

FIG. 1 illustrates various components of a computing system in which an exemplary embodiment of initiate multiple applications can be implemented.

FIG. 2 illustrates an embodiment of a transition from an exemplary user interface logon page to an exemplary user interface start page.

FIG. 3 illustrates various features of an embodiment of a user interface start page.

FIG. 4 illustrates an embodiment of a transition from an exemplary user interface start page to an exemplary user interface desktop page.

FIG. 5 is a flow diagram that illustrates an exemplary method for an embodiment of initiate multiple applications.

FIG. 6 is a flow diagram that illustrates an exemplary method for an embodiment of initiate multiple applications.

FIG. 7 illustrates exemplary computing systems, devices, and components in an environment that initiate multiple applications can be implemented.

### DETAILED DESCRIPTION

A user interface transition is described in which a user interface logon page is displayed from which a user can log onto a computing system. The user interface logon page includes selectable logon controls that each have a corresponding user-identifiable indicator, such as a user name and/or an image associated with a particular user. A first transition from the user interface logon page to a user interface start page is initiated in response to a selectable logon control being selected, and the user-identifiable indicator(s) corresponding to the selectable logon control are displayed uninterrupted throughout the transition.

The user interface start page is displayed with the user-identifiable indicator(s) (e.g., the user name, image, or associated information) corresponding to the selectable logon control. A second transition from the user interface start page to a user interface desktop page is initiated in response to a user-selectable control being selected on the user interface start page. The user-identifiable indicator(s) corresponding to the selectable logon control are displayed uninterrupted throughout the continued transition. The user interface desktop page is displayed with the user-identifiable indicator(s) from the user interface logon page.

The user interface start page includes the user-identifiable indicator associated with the user of the computing system to indicate that the user is logged-on to the computing system. The user interface start page also includes user-selectable controls, information, and/or resources from one or more regions of the user interface desktop page. The user-selectable controls, information, and resources are displayed on the user interface start page because they are likely of interest to, and/or associated with, the particular user logged onto the computing system. The user interface start page represents a tailored and optionally-configurable representation of a computing session displayed as a desktop page after the transition from the user interface start page. This continuous, seamless, and uninterrupted transition from the user interface logon page to the user interface start page, and from the start page to the user interface desktop page enhances the overall user experience of a computing session.

Further, the user can initiate multiple applications from the user interface start page or from the user interface desktop page. In an implementation, a user interface start page or desktop page includes a user-selectable control to initiate that multiple applications start together at approximately a same time. The user interface includes user-selectable configurations to designate a multiple application start-up configuration. For example, a user can select groups of application programs to start together such as application programs that were executing when a previous computing session was discontinued, application programs often selected for use by the user, application programs recently selected for use by the user, and/or application programs most used by the user.

The following discussion is directed to systems and methods for initiate multiple applications. While features of the described systems and methods can be implemented in any number of different computing environments, they are described in the context of the following exemplary implementations.

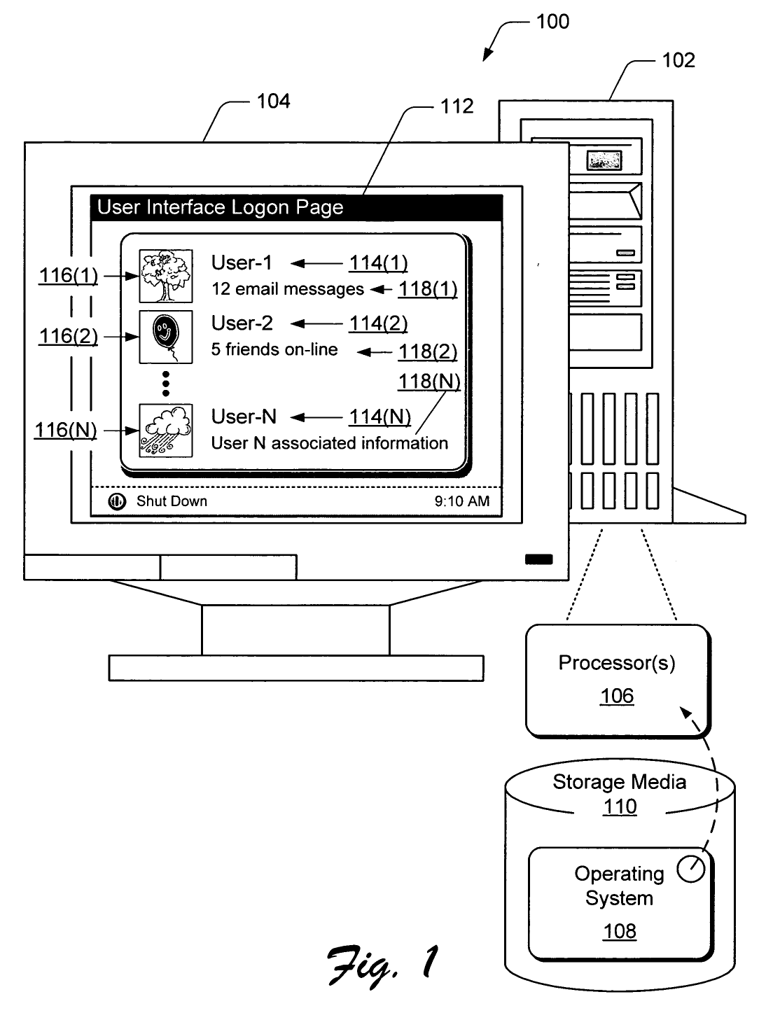

FIG. 1 illustrates various components of a computing system 100 in which an exemplary embodiment of initiate multiple applications can be implemented. The computing system 100 includes a computing device 102 and a display device 104 to display operating system user interfaces (also referred to herein as various user interface pages). The computing device 102 includes one or more processors 106 (e.g., any of microprocessors, controllers, and the like) which execute an operating system 108 and process computer executable instructions to implement features of initiate multiple applications.

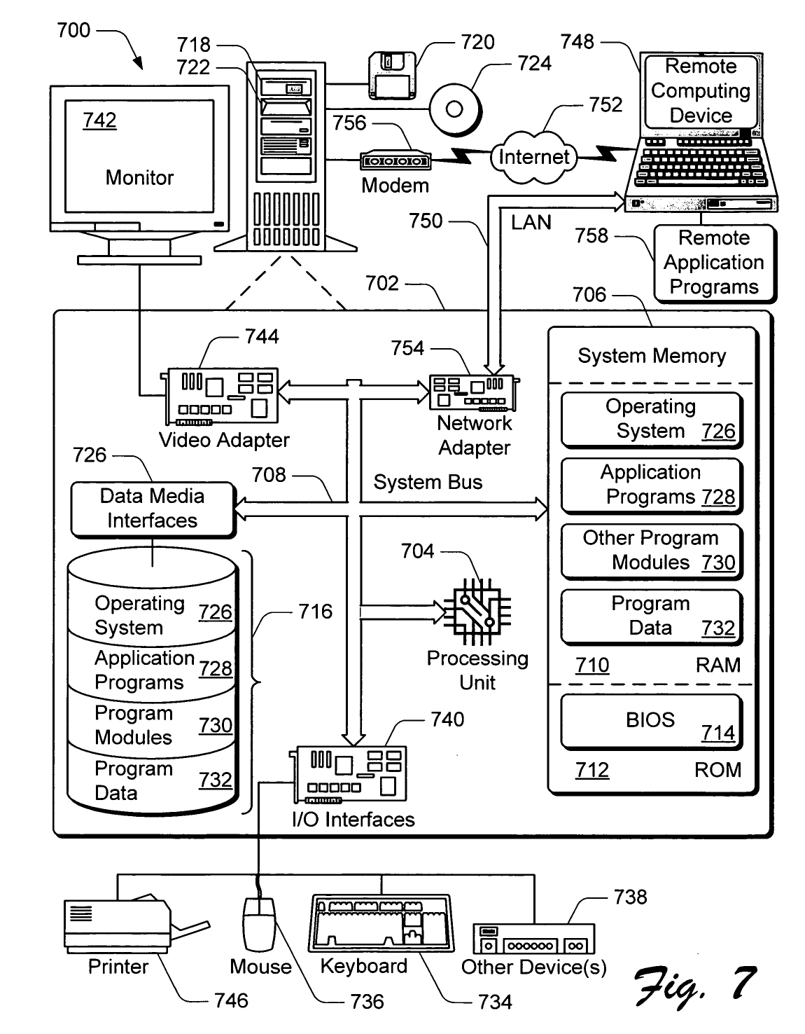

The computing system 100 can be implemented with one or more memory components, such as any form of storage media 110 (e.g., any of RAM, ROM, and the like), which maintains operating system 108. The computing system 100 may be implemented with any number and combination of differing components as further described below with reference to the exemplary computing systems, devices, and components shown in FIG. 7. Further, although operating system 108 is illustrated and described as a single application program, the operating system 108 can be implemented as several component applications distributed to each perform one or more functions of initiate multiple applications.

In this example, display device 104 displays a user interface logon page 112 that includes any number of selectable logon controls 114(1-N) each corresponding to a user of the computing system 100. Typically, when computing device 102 is turned-on, or logged-off of by another user, the operating system 108 initiates a display of the user interface logon page 112 so that any user of the computing system 100 can logon to the computing device 102.

The user interface logon page 112 also includes user-identifiable indicators that correspond to, or are implemented as, the selectable logon controls 114(1-N). For example, a selectable logon control 114 can be displayed as a user name to identify a user of the computing system 100. Alternatively and/or in addition, a corresponding user-identifiable indicator can be displayed as an image that is recognizable and optionally configurable by a user, such as images 116(1-N) that each correspond to a respective selectable logon control 114(1-N). A user-identifiable image 116 may also be implemented as a selectable logon control 114 on a user interface logon page 112.

The user interface logon page 112 may also include user information 118(1-N) that corresponds to the selectable logon controls 114(1-N) and/or user-identifiable indicators (e.g., images) 116(1-N). In this example, User-1 114(1) corresponding user information 118(1) indicates that User-1 has twelve new e-mail messages, and User-2 114(2) corresponding user information 118(2) indicates that User-2 currently has five friends on-line. User information 118 corresponding to a selectable logon control 114 can include any type or form of information, to include text, a graphic, an image, and/or any combination thereof.

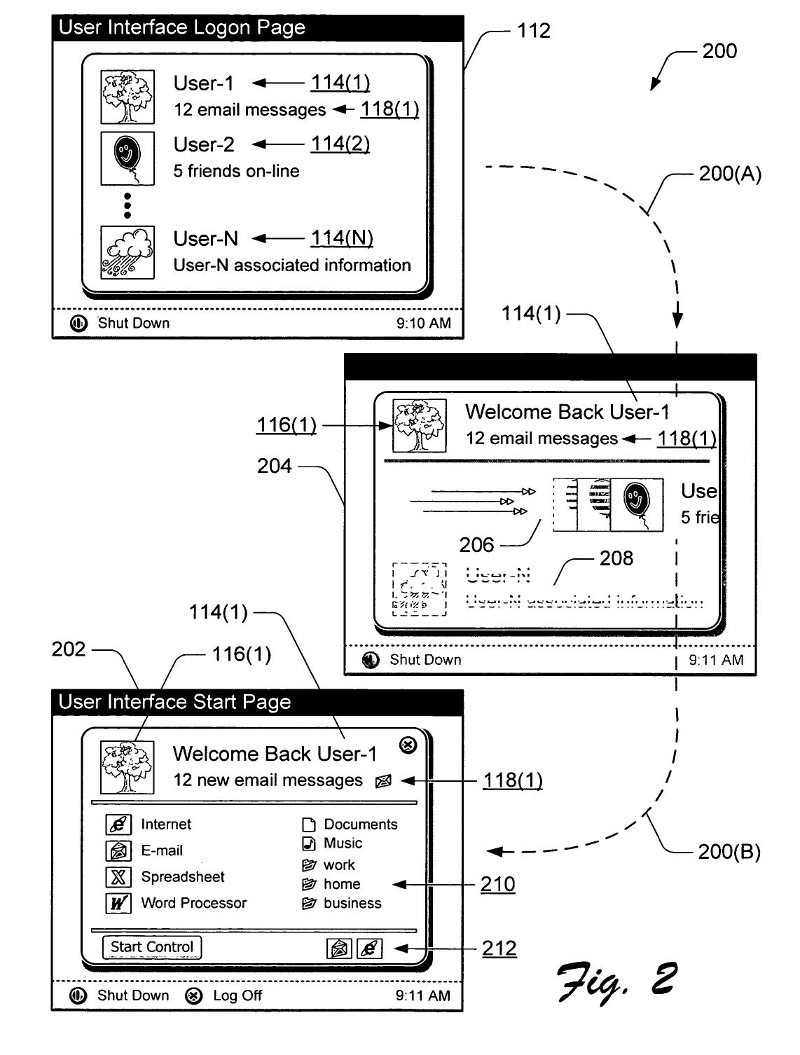

FIG. 2 illustrates an embodiment of a transition 200 from the exemplary user interface logon page 112 to an exemplary user interface start page 202. The transition 200 is illustrated as a continually evolving display with a transition 200(A) from the user interface logon page 112 to transition page(s) 204 and continuing with a transition 200(B) from the transition page(s) 204 to the user interface start page 202. Although shown as only one page or user interface display, transition page 204 is representative of any number of “frames” (e.g., to use a video reference) to represent a continuous, seamless, and uninterrupted transition from the user interface logon page 112 to the user interface start page 202.

During the transition 200, a user-identifiable indicator corresponding to a selectable logon control is displayed uninterrupted throughout the transition. For example, in an event that a user of the computing system 100 selects the selectable logon control 114(1), the user's name, User-1, and/or the corresponding image 116(1) is displayed throughout the transition 200(A-B) on the transition page(s) 204 and on the user interface start page 202. Additionally, User-1 corresponding user information 118(1) may also be displayed throughout the transition 200(A-B) on the transition page(s) 204 and on the user interface start page 202.

The transition page(s) 204 can be visually animated to convey the transition 200 to a user. For example, while the user-identifiable indicators corresponding to the selected logon control for User-1 114(1) are continually displayed throughout the transition, the indicators and information corresponding to User-2 114(2) and User-N 114(N) are eliminated from the display. For example, User-2 114(2) is shown to slide right 206 and off of the display page during the transition page(s) 204. User-N 114(N) is shown to fade away 208 from view on the transition page(s) 204. The indicators and information corresponding to the selectable logon controls that are not selected can be eliminated from the display utilizing any number of methods and techniques to visually animate the transition 200.

The exemplary user interface start page 202 can be displayed with any number of selectable controls 210, information, and application program selectable start controls 212 that, when selected, initiate a display of information and/or an application program associated with the particular user logged-on to the computing system 100. The user interface start page 202 includes (optionally user-definable) information and selectable controls that are more likely of interest and/or associated with the particular user, such as when the user starts the computing device 102 or returns to a computing session. For example, a user interface start page may include any one or combination of application programs, documents, Web links, personal contacts, e-mail, and any other form of information and images such as live data feeds of news, sports, weather, and the like.

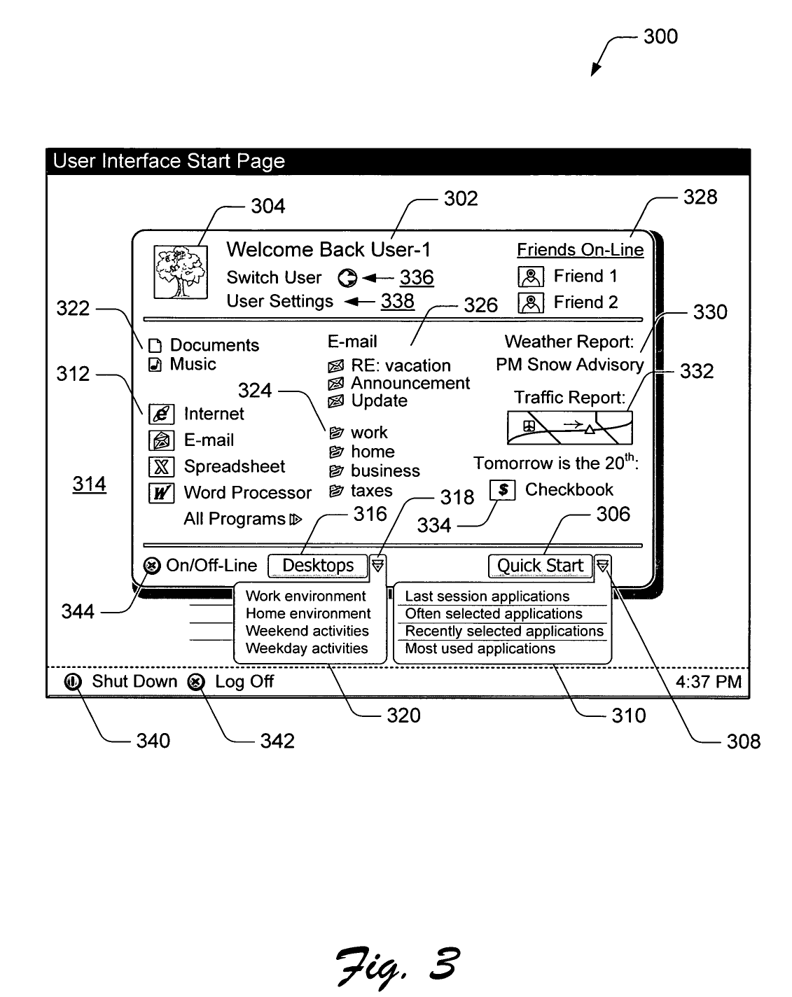

FIG. 3 illustrates various features of an embodiment of a user interface start page 300 which includes user-identifiable indicators associated with a user of the computing system 100 (FIG. 1) to indicate that the user is logged-on to the computing system. For example, the user interface start page 300 includes a user name 302 and an image 304 as user-identifiable indicators. The user interface start page 300 also includes resources, information, and selectable controls that are more likely of interest and/or associated with the particular user (e.g., User-1 in this example).

The user interface start page 300 includes a start control 306 that is user-selectable to initiate that multiple application programs start together at approximately a same time (e.g., the applications start together after a single user input). The start control 306 may be configurable, or a selectable configuration control 308 may be implemented, such that a user can select to initiate different groups 310 of application programs. In this example, the groups of application programs that can be selected to start together include application programs that were executing when a previous computing session was discontinued, application programs often selected for use by the user, application programs recently selected for use by the user, and/or application programs most used by the user (e.g., application programs executing for at least a minimum duration).

In this example, a user may also select any number of application programs from a list of application programs 312 to initiate that the multiple selected application programs start together at approximately a same time. For example, a user of computing system 100 can individually select various applications, such as an e-mail application, a Web browser, and a word processor from the list of application programs 312, and then initiate that the various selected application programs start together. To initiate starting the selected application programs, a user may simply mouse-click in a region 314 of the user interface start page 300 that is outside of the region containing the information and selectable controls. Alternatively, a user may initiate the selected various applications with a designated user-selectable control, with a keystroke combination input from a keyboard, or with any number of other user-input techniques and/or combinations of sequenced inputs. Further, although initiating multiple application programs is described and illustrated with reference to the user interface start page 300, multiple application programs can also be started together from any user interface desktop page, such as desktop page 402.

The user interface start page 300 includes a desktop selection control 316 that may be configurable, or a selectable configuration control 318 may be implemented, such that a user can select from various desktop pages 320 as a beginning of a computing session. In this example, the various desktop pages 320 include a work environment desktop, a home environment desktop, a weekend activities desktop, and a weekday activities desktop.

A user can select any such desktop environment or page to coincide with a user's “persona” for a particular computing session. For example, a work environment desktop may include information corresponding to a place of business and selectable controls corresponding to work-related application programs. A home environment desktop may include information corresponding to a user's home life, such as the local weather, a TV guide, a movie listing for local movie show times, a personal e-mail account, personal Web links, a personal desktop background image, and/or any combination of these and other information and resources. Similarly, a weekend activities desktop may include some or all of the information and resources included in a home environment desktop, and a weekday activities desktop may include some combination of the information and resources included in the work environment desktop and the home environment desktop. The various desktop environments are configurable for efficiency and ease-of-use corresponding to a particular environment, or persona, that a user selects for a computing session.

The list of application programs 312 may include application programs recently accessed by the user (e.g., in previous computing sessions) and/or application programs designated for user-selection from the user interface start page 300. The user interface start page 300 also includes a list of documents 322 recently accessed by the user and/or documents designated for user-selection from the user interface start page, and a list of directory locations 324 in computing system 100 recently accessed by the user and/or designated for user-selection from the user interface start page. The start page 300 may also include other user-associated information and resources such as a list of e-mail notifications 326 that each correspond to an e-mail received after a previous computing session was discontinued, and a list of on-line users 328 (e.g., friends or buddies that are interconnected on-line). A user can select the friends or on-line users for display notification on the user interface start page 300 when the a designated user is on-line.

The user interface start page 300 can also include any form of a time-based and/or a date-based display of information which may correspond to an environment of the user. For example, a weather report 330 is displayed to advise of impending weather in an area where the user lives, and, after 4:30 p.m. on a weekday, a traffic report 332 may be displayed to advise the user of the traffic conditions for a commute after work. As shown in the user interface start page 300, the time-based and date-based display of information may be text, a graphic, an image, and/or any other form of indication. An example of a date-based user-selectable control 334 is displayed for a financial application program associated with a user that regularly accesses a checkbook on the 20^{th} of every month. These are only some examples of the many possible time-based and/or date-based information and application programs that can be displayed on a user interface start page.

The user interface start page 300 can also include various other user-selectable controls and information, such as a switch user control 336 (e.g., a “back” button) to initiate a transition back to the user interface logon page 112 (FIGS. 1-2), and a user settings change control 338 by which a user can configure and change the display settings of the user interface start page 300 and the list information included in the display. The user interface start page 300 also includes a user-selectable shut down control 340 to shutdown computing device 102, and a user-selectable logoff control 342 to logoff of the computing system 100.

The user interface start page 300 may also include a user-configurable on-line selectable control 344 with which a user can designate an on-line status before transitioning onto a desktop environment. Typically, when a user logs-on to a computing system, other users may be configured for display notification that the user is now on-line. However, with the on-line selectable control 344, the user can choose to transition to a desktop environment without other users being notified of a change in the user's on-line status.

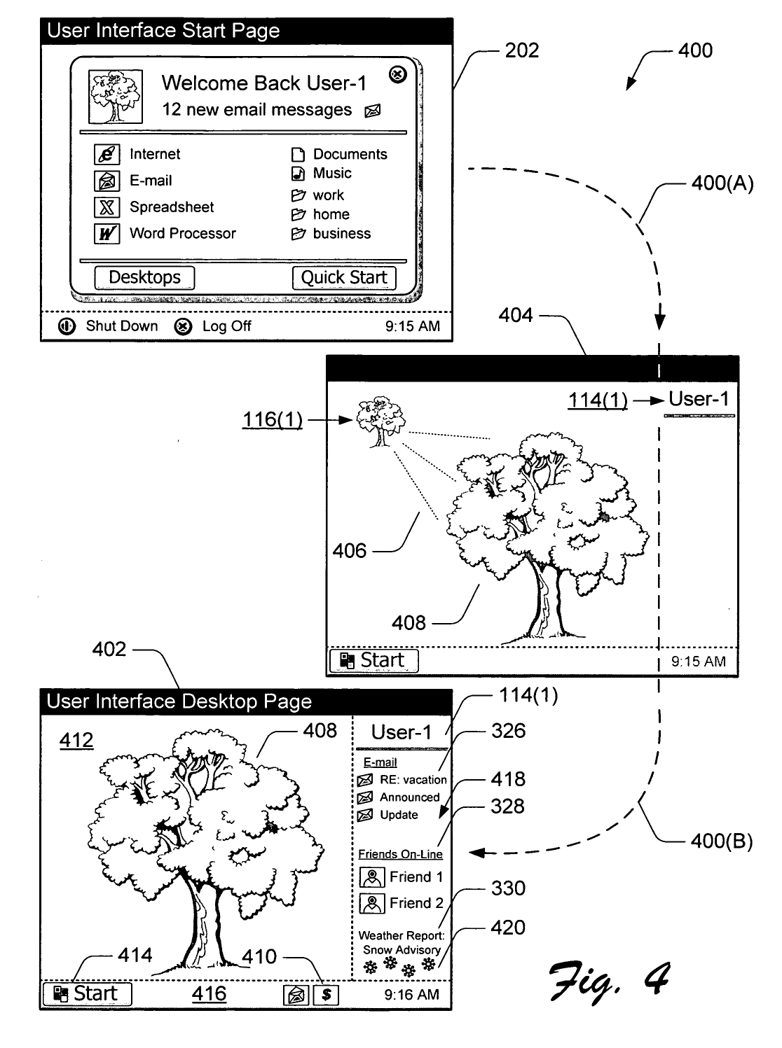

FIG. 4 illustrates an embodiment of a transition 400 from the exemplary user interface start page 202 to an exemplary user interface desktop page 402. The transition 400 is illustrated as a continually evolving display with a transition 400(A) from the user interface start page 202 to transition page(s) 404 and continuing with a transition 400(B) from the transition page(s) 404 to the user interface desktop page 402. Although shown as only one transition page or user interface display, transition page 404 is representative of any number of “frames” (e.g., to use a video reference) to represent a continuous, seamless, and uninterrupted transition from the user interface start page 202 to the user interface desktop page 402.

During the transition 400, a user-identifiable indicator corresponding to a selectable logon control (e.g., selected from the logon page 112) is displayed uninterrupted throughout the transition. For example, in an event that a user of the computing system 100 selects the selectable logon control 114(1), the user's name, User-1, and/or the corresponding image 116(1) is displayed throughout the transition 400(A-B) on the transition page(s) 404 and on the user interface desktop page 402. Additionally, the corresponding image 116(1) (or a portion of the image) may transform 406 to a full-size page display 408 of the image while being displayed throughout the transition 400(A-B) on the transition page(s) 404 and on the user interface desktop page 402. Further, the transition page(s) 404 can be visually animated to convey the transition 400 to a user utilizing any number of methods and techniques to visually animate the transition 400.

The exemplary user interface desktop page 402 can be displayed with any number of selectable controls, information, resources, and application program selectable start controls 410 that, when selected, initiate a display of information and/or an application program associated with the particular user logged-on to the computing system 100. The user interface desktop page 402 includes (optionally user-definable) various regions in which the user information and resources are displayed.

In this example, user interface desktop page 402 includes a desktop region 412, a start menu region 414 (e.g., a user-selectable control), a taskbar region 416, and a sidebar region 418. The various regions of the user interface desktop page 402 may include (optionally user-definable) any one or combination of application programs, documents, Web links, personal contacts, e-mail, and any other form of information, resources, and images such as live data feeds of news, sports, weather, and the like. For example, the desktop region includes the full-size page display 408 of the image 116 corresponding to the user currently logged on to computing system 100. Further, the sidebar region 418 includes the list of e-mail notifications 326 that each correspond to an e-mail received after a previous computing session was discontinued, the list of on-line users 328, and the weather report 330. The sidebar region 418 may also include any form of an image or graphic, such as image 420 corresponding to the weather report 330.

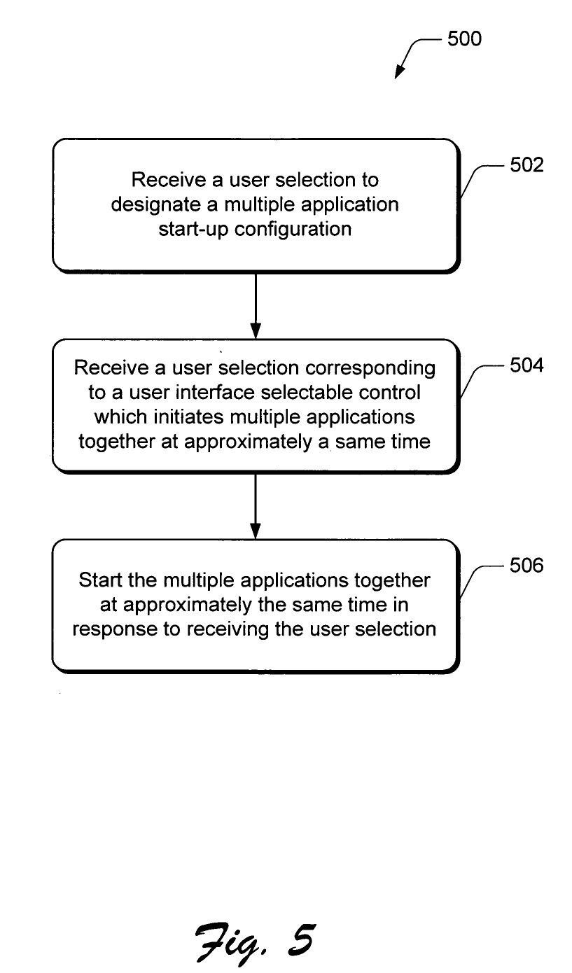

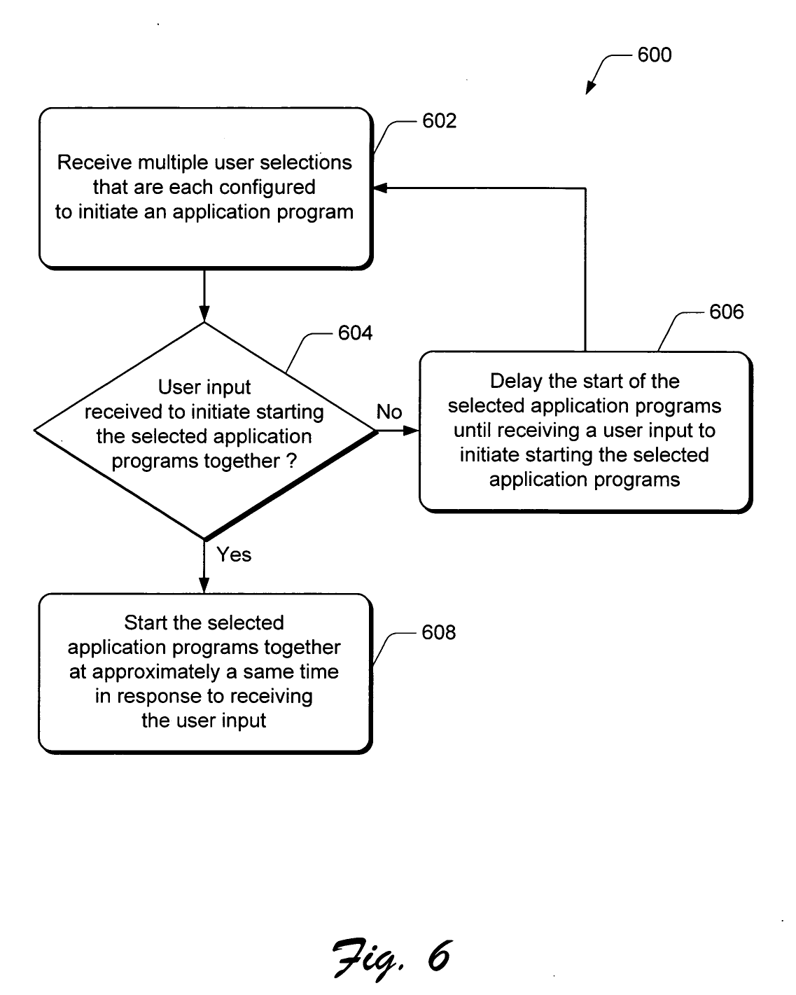

Methods for initiate multiple applications, such as exemplary methods 500 and 600 described with reference to FIGS. 5 and 6, respectively, may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 5 illustrates an exemplary method 500 for an embodiment of initiate multiple applications. The order in which the method is described is not intended to be construed as a limitation, and any number of the described method blocks can be combined in any order to implement the method. Furthermore, the method can be implemented in any suitable hardware, software, firmware, or combination thereof.

At block 502, a user selection is received to designate a multiple application start-up configuration. For example, selectable configuration control 308 (FIG. 3) on the user interface start page 300 can be selected to designate a multiple application start-up configuration that includes application programs that were executing when a previous computing session was discontinued, application programs often selected for use, application programs recently selected for use, and/or application programs most used. In an embodiment, the user selection may be received to configure the user interface selectable control which is user-configurable to designate the multiple application program start-up configuration.

At block 504, a user selection corresponding to a user interface selectable control is received which initiates multiple applications together at approximately a same time. For example, the start control 306 (FIG. 3) is user-selectable to initiate a user-defined group of applications, a group of applications executing when a previous computing session was discontinued, a group of applications often selected for use, a group of applications recently selected for use, and/or a group of applications most used (e.g., previously executing for at least a minimum duration).

At block 506, the multiple applications are started together at approximately the same time in response to receiving the user selection. For example, the user-defined group of applications, the group of previously executing applications, the group of often selected applications, the group of recently selected applications, and/or the group of applications executing for at least the minimum duration are started together at approximately the same time.

FIG. 6 illustrates an exemplary method 600 for an embodiment of initiate multiple applications. The order in which the method is described is not intended to be construed as a limitation, and any number of the described method blocks can be combined in any order to implement the method. Furthermore, the method can be implemented in any suitable hardware, software, firmware, or combination thereof.

At block 602, multiple user selections are received that are each configured to initiate an application program. For example, a user can select any number of application programs from a list of application programs 312 (FIG. 3) on the user interface start page 300 to initiate that the multiple selected application programs start together at approximately a same time.

At block 604, a determination is made as to whether a user input has been received to initiate starting the selected application programs together. If a user input to start the selected application programs together has not been received (i.e., “no” from block 604), then the start of the selected application programs is delayed until receiving the user input to initiate starting the selected application programs at block 606. If a user input to start the selected application programs together has been received (i.e., “yes” from block 604), then the selected application programs are started together at approximately a same time in response to receiving the user input at block 608. The user input to initiate starting the selected application programs can be received as a user selection that does not correspond to a user-selectable control for an application program. For example, a user can initiate starting the selected application programs by selecting in a region 314 of the user interface start page 300 that is outside of the region containing the information and selectable controls 312.

FIG. 7 illustrates an exemplary computing environment 700 within which initiate multiple applications systems and methods, as well as the computing, network, and system architectures described herein, can be either fully or partially implemented. Exemplary computing environment 700 is only one example of a computing system and is not intended to suggest any limitation as to the scope of use or functionality of the architectures. Neither should the computing environment 700 be interpreted as having any dependency or requirement relating to any one or combination of components illustrated in the exemplary computing environment 700.

The computer and network architectures in computing environment 700 can be implemented with numerous other general purpose or special purpose computing system environments or configurations. Examples of well known computing systems, environments, and/or configurations that may be suitable for use include, but are not limited to, personal computers, server computers, client devices, hand-held or laptop devices, microprocessor-based systems, multiprocessor systems, set top boxes, programmable consumer electronics, network PCs, minicomputers, mainframe computers, gaming consoles, distributed computing environments that include any of the above systems or devices, and the like.

The computing environment 700 includes a general-purpose computing system in the form of a computing device 702. The components of computing device 702 can include, but are not limited to, one or more processors 704 (e.g., any of microprocessors, controllers, and the like), a system memory 706, and a system bus 708 that couples the various system components. The one or more processors 704 process various computer executable instructions to control the operation of computing device 702 and to communicate with other electronic and computing devices. The system bus 708 represents any number of several types of bus structures, including a memory bus or memory controller, a peripheral bus, an accelerated graphics port, and a processor or local bus using any of a variety of bus architectures.

Computing environment 700 includes a variety of computer readable media which can be any media that is accessible by computing device 702 and includes both volatile and non-volatile media, removable and non-removable media. The system memory 706 includes computer-readable media in the form of volatile memory, such as random access memory (RAM) 710, and/or non-volatile memory, such as read only memory (ROM) 712. A basic input/output system (BIOS) 714 maintains the basic routines that facilitate information transfer between components within computing device 702, such as during start-up, and is stored in ROM 712. RAM 710 typically contains data and/or program modules that are immediately accessible to and/or presently operated on by one or more of the processors 704.

Computing device 702 may include other removable/non-removable, volatile/non-volatile computer storage media. By way of example, a hard disk drive 716 reads from and writes to a non-removable, non-volatile magnetic media (not shown), a magnetic disk drive 718 reads from and writes to a removable, non-volatile magnetic disk 720 (e.g., a “floppy disk”), and an optical disk drive 722 reads from and/or writes to a removable, non-volatile optical disk 724 such as a CD-ROM, digital versatile disk (DVD), or any other type of optical media. In this example, the hard disk drive 716, magnetic disk drive 718, and optical disk drive 722 are each connected to the system bus 708 by one or more data media interfaces 726. The disk drives and associated computer readable media provide non-volatile storage of computer readable instructions, data structures, program modules, and other data for computing device 702.

Any number of program modules can be stored on the hard disk 716, magnetic disk 720, optical disk 724, ROM 712, and/or RAM 710, including by way of example, an operating system 726, one or more application programs 728, other program modules 730, and program data 732. Each of such operating system 726, application programs 728, other program modules 730, and program data 732 (or some combination thereof) may include an embodiment of the systems and methods described herein.

Computing device 702 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, other wireless media, and any combination thereof.

A user can interface with computing device 702 via any number of different input devices such as a keyboard 734 and pointing device 736 (e.g., a “mouse”). Other input devices 738 (not shown specifically) may include a microphone, joystick, game pad, controller, satellite dish, serial port, scanner, and/or the like. These and other input devices are connected to the processors 704 via input/output interfaces 740 that are coupled to the system bus 708, but may be connected by other interface and bus structures, such as a parallel port, game port, and/or a universal serial bus (USB).

A monitor 742 or other type of display device can be connected to the system bus 708 via an interface, such as a video adapter 744. In addition to the monitor 742, other output peripheral devices can include components such as speakers (not shown) and a printer 746 which can be connected to computing device 702 via the input/output interfaces 740.

Computing device 702 can operate in a networked environment using logical connections to one or more remote computers, such as a remote computing device 748. By way of example, the remote computing device 748 can be a personal computer, portable computer, a server, a router, a network computer, a peer device or other common network node, and the like. The remote computing device 748 is illustrated as a portable computer that can include many or all of the elements and features described herein relative to computing device 702.

Logical connections between computing device 702 and the remote computing device 748 are depicted as a local area network (LAN) 750 and a general wide area network (WAN) 752. Such networking environments are commonplace in offices, enterprise-wide computer networks, intranets, and the Internet. When implemented in a LAN networking environment, the computing device 702 is connected to a local network 750 via a network interface or adapter 754. When implemented in a WAN networking environment, the computing device 702 typically includes a modem 756 or other means for establishing communications over the wide area network 752. The modem 756, which can be internal or external to computing device 702, can be connected to the system bus 708 via the input/output interfaces 740 or other appropriate mechanisms. The illustrated network connections are exemplary and other means of establishing communication link(s) between the computing devices 702 and 748 can be utilized.

In a networked environment, such as that illustrated with computing environment 700, program modules depicted relative to the computing device 702, or portions thereof, may be stored in a remote memory storage device. By way of example, remote application programs 758 are maintained with a memory device of remote computing device 748. For purposes of illustration, application programs and other executable program components, such as the operating system 726, are illustrated herein as discrete blocks, although it is recognized that such programs and components reside at various times in different storage components of the computing device 702, and are executed by the processors 704 of the computing device.

Although embodiments of initiate multiple applications have been described in language specific to structural features and/or methods, it is to be understood that the subject of the appended claims is not necessarily limited to the specific features or methods described. Rather, the specific features and methods are disclosed as exemplary implementations of initiate multiple applications.

1. A user interface, comprising:
a selectable control configured to initiate that multiple applications start together at approximately a same time; and
selectable configurations each configured for a user selection to designate a multiple application start-up configuration.

2. A user interface as recited in claim 1, wherein the selectable control is user-configurable to designate a multiple application start-up configuration.

3. A user interface as recited in claim 1, wherein the multiple applications are a group of applications executing when a previous computing session was discontinued, and wherein the selectable control is further configured to initiate that the group of previously executing applications start together.

4. A user interface as recited in claim 1, wherein the multiple applications are a group of applications often selected for use by the user, and wherein the selectable control is further configured to initiate that the group of often selected applications start together.

5. A user interface as recited in claim 1, wherein the multiple applications are a group of applications recently selected for use by the user, and wherein the selectable control is further configured to initiate that the group of recently selected applications start together.

6. A user interface as recited in claim 1, wherein the multiple applications are a group of applications previously executing for at least a minimum duration, and wherein the selectable control is further configured to initiate that the group of applications executing for at least the minimum duration start together.

7. A user interface as recited in claim 1, wherein the selectable configurations include at least one of (i) a configuration to designate a group of applications executing when a previous computing session was discontinued, (ii) a configuration to designate a group of applications often selected for use, (iii) a configuration to designate a group of applications recently selected for use, and (iv) a configuration to designate a group of applications previously executing for at least a minimum duration.

8. A user interface selectable control configured for user selection to start multiple application programs together at approximately a same time.

9. A user interface selectable control as recited in claim 8, wherein the user interface selectable control is user-configurable to designate a multiple application program start-up configuration.

10. A user interface selectable control as recited in claim 8, wherein the multiple application programs are a user-defined group of application programs, and wherein the user interface selectable control is further configured to start the user-defined group of applications together.

11. A user interface selectable control as recited in claim 8, wherein the multiple application programs are a group of application programs executing when a previous computing session was discontinued, and wherein the user interface selectable control is further configured to initiate that the group of previously executing application programs start together.

12. A user interface selectable control as recited in claim 8, wherein the multiple application programs are a group of application programs often selected for use by the user, and wherein the user interface selectable control is further configured to initiate that the group of often selected application programs start together.

13. A user interface selectable control as recited in claim 8, wherein the multiple application programs are a group of application programs recently selected for use by the user, and wherein the user interface selectable control is further configured to initiate that the group of recently selected application programs start together.

14. A user interface selectable control as recited in claim 8, wherein the multiple application programs are a group of application programs previously executing for at least a minimum duration, and wherein the user interface selectable control is further configured to initiate that the group of application programs executing for at least the minimum duration start together.

15. A user interface selectable control as recited in claim 8, wherein the user interface selectable control is user-configurable to designate a multiple application program start-up configuration that includes at least one of (i) a configuration to designate a group of application programs executing when a previous computing session was discontinued, (ii) a configuration to designate a group of application programs often selected for use, (iii) a configuration to designate a group of application programs recently selected for use, and (iv) a configuration to designate a group of application programs previously executing for at least a minimum duration.

16. A method, comprising:
receiving a user selection corresponding to a user interface selectable control which initiates multiple applications together at approximately a same time; and
starting the multiple applications in response to receiving the user selection.

17. A method as recited in claim 16, further comprising receiving a user selection to designate a multiple application start-up configuration.

18. A method as recited in claim 16, further comprising receiving a user selection to configure the user interface selectable control which is user-configurable to designate a multiple application program start-up configuration.

19. A method as recited in claim 16, wherein receiving the user selection initiates a user-defined group of applications, and wherein starting the multiple applications includes starting the user-defined group of applications together at approximately the same time.

20. A method as recited in claim 16, wherein receiving the user selection initiates a group of applications executing when a previous computing session was discontinued, and wherein starting the multiple applications includes starting the group of previously executing applications together at approximately the same time.

21. A method as recited in claim 16, wherein receiving the user selection initiates a group of applications often selected for use by the user, and wherein starting the multiple applications includes starting the group of often selected applications together at approximately the same time.

22. A method as recited in claim 16, wherein receiving the user selection initiates a group of applications recently selected for use by the user, and wherein starting the multiple applications includes starting the group of recently selected applications together at approximately the same time.

23. A method as recited in claim 16, wherein receiving the user selection initiates a group of applications previously executing for at least a minimum duration, and wherein starting the multiple applications includes starting the group of applications executing for at least the minimum duration together at approximately the same time.

24. A method as recited in claim 16, further comprising receiving a user selection to designate a multiple application start-up configuration that includes at least one of (i) a configuration to designate a group of applications executing when a previous computing session was discontinued, (ii) a configuration to designate a group of applications often selected for use, (iii) a configuration to designate a group of applications recently selected for use, and (iv) a configuration to designate a group of applications previously executing for at least a minimum duration.

25. One or more computer readable media comprising computer executable instructions that, when executed, direct a computing system to:
process a user selection corresponding to a user interface selectable control which initiates multiple applications together at approximately a same time; and
start the multiple applications in response to receiving the user selection.

26. One or more computer readable media as recited in claim 25, further comprising computer executable instructions that, when executed, direct the computing system to process a user selection to designate a multiple application start-up configuration.

27. One or more computer readable media as recited in claim 25, further comprising computer executable instructions that, when executed, direct the computing system to process a user selection to configure the user interface selectable control which is user-configurable to designate a multiple application program start-up configuration.

28. One or more computer readable media as recited in claim 25, further comprising computer executable instructions that, when executed, direct the computing system to process the user selection to initiate a user-defined group of applications, and start the user-defined group of applications together at approximately the same time.

29. One or more computer readable media as recited in claim 25, further comprising computer executable instructions that, when executed, direct the computing system to process the user selection to initiate a group of applications executing when a previous computing session was discontinued, and starting the group of previously executing applications together at approximately the same time.

30. One or more computer readable media as recited in claim 25, further comprising computer executable instructions that, when executed, direct the computing system to process the user selection to initiate a group of applications often selected for use by the user, and start the group of often selected applications together at approximately the same time.

31. One or more computer readable media as recited in claim 25, further comprising computer executable instructions that, when executed, direct the computing system to process the user selection to initiate a group of applications recently selected for use by the user, and start the group of recently selected applications together at approximately the same time.

32. One or more computer readable media as recited in claim 25, further comprising computer executable instructions that, when executed, direct the computing system to process the user selection to initiate a group of applications previously executing for at least a minimum duration, and start the group of applications executing for at least the minimum duration together at approximately the same time.

33. One or more computer readable media as recited in claim 25, further comprising computer executable instructions that, when executed, direct the computing system to process a user selection to designate a multiple application start-up configuration that includes at least one of (i) a configuration to designate a group of applications executing when a previous computing session was discontinued, (ii) a configuration to designate a group of applications often selected for use, (iii) a configuration to designate a group of applications recently selected for use, and (iv) a configuration to designate a group of applications previously executing for at least a minimum duration.

34. A method, comprising:
receiving multiple user selections each configured to initiate an application program;
receiving a user input to initiate starting the selected application programs together at approximately a same time; and
starting the selected application programs in response to receiving the user input.

35. A method as recited in claim 34, further comprising delaying the start of the selected application programs until receiving the user input to initiate starting the selected application programs.

36. A method as recited in claim 34, wherein receiving the user input to initiate starting the selected application programs includes receiving a user selection that does not correspond to a user-selectable control.

37. One or more computer readable media comprising computer executable instructions that, when executed, direct a computing system to:
receive multiple user selections each configured to initiate an application program;
process a user input to initiate starting the selected application programs together at approximately a same time; and
start the selected application programs in response to receiving the user input.

38. One or more computer readable media as recited in claim 37, further comprising computer executable instructions that, when executed, direct the computing system to delay the start of the selected application programs until receiving the user input to initiate starting the selected application programs.
